(19) United States
(12) Patent Application Publication
(10) Pub. No.: US 2012/0002023 A1
(43) Pub. Date: Jan. 5, 2012

(54) SPATIAL IMAGE DISPLAY DEVICE

(75) Inventors: Masahiro Yamada, Kanagawa (JP); Sunao Aoki, Kanagawa (JP)

(73) Assignee: SONY CORPORATION, Tokyo (JP)

(21) Appl. No.: 13/143,031

(22) PCT Filed: Jan. 18, 2010
(86) PCT No.: PCT/JP2010/050473

§ 371 Date: Jun. 30, 2011

(30) Foreign Application Priority Data
Jan. 23, 2009 (JP) 2009-013671

(51) Int. Cl. H04N 13/04

(52) U.S. Cl. 348/54; 348/E13.075

(57) ABSTRACT

Provided is a spatial image display device capable of forming more natural spatial images even with a simple configuration. In the spatial image display device 10, a two-dimensional display image corresponding to a video signal is generated by a display section 2. Display image light corresponding to one group of pixels 22 in the display section 2 is collectively subjected to wavefront transformation and collectively deflected by one liquid optical element 41 corresponding to that one group of pixels 22. Therefore, compared with a case where one liquid optical element 41 is provided for one pixel 22, a larger number of various different two-dimensional display image light are to be emitted all at once toward different directions in the horizontal plane, without increasing the frame rate in the display section 2.

The present application is a 371 U.S. National Stage filing of PCT application PCT/JP2010/050473, filed Jan. 18, 2010, which claims priority to Japanese Patent Application Number JP 2009-013671, filed Jan. 23, 2009. The present application claims priority to these previously filed applications

### TECHNICAL FIELD

The present invention relates to a spatial image display device that displays three-dimensional video of an object in the space.

### BACKGROUND ART

The generation of three-dimensional video is realized by the use of the human physiological functions of perception. That is, observers perceive three-dimensional objects in the course of the comprehensive processing in their brains based on the perception of a displacement of images respectively entering their left and right eyes (binocular parallax) and the perception with the angle of convergence, the perception with the physiological function that occurs when adjusting the focal length of crystalline lenses of the eyes using the ciliary body and the Zinn's zonule (the focal length adjustment function), and the perception of a change of image(s) seen when a motion is made (motion parallax). As a previous method of generating three-dimensional video utilizing the “binocular parallax” and the “angle of convergence” among the physiological functions of perception described above, there is a method of using glasses having different-colored left and right lenses to provide different images (parallax images) to left and right eyes, and a method of using goggles with a liquid crystal shutter to provide parallax images to left and right eyes by switching the liquid crystal shutter at a high speed, for example. There is also a method of representing three-dimensional images using a lenticular lens to allocate, to left and right eyes, images displayed on a two-dimensional display device respectively for the left and right eyes. Furthermore, similarly to such a method of using the lenticular lens, there is also a method developed for representing three-dimensional images by using a mask provided on the surface of a liquid crystal display to allow a right eye to view images for the right eye, and a left eye to view images for the left eye.

However, the methods of acquiring parallax images using the special glasses and goggles as described above are very annoying for the observers. On the other hand, with the method of using the lenticular lens, for example, it is necessary to divide the region of a single two-dimensional image display device into a region for the right eye and a region for the left eye. Therefore, such a method has an issue of being not appropriate for displaying images with high definition.

Patent Literature 1 proposes a three-dimensional display device including a plurality of one-dimensional display devices, and deflection means for deflecting a display pattern from each of the one-dimensional display devices in the direction same as the placement direction thereof. According to this three-dimensional display device, a plurality of output images are to be recognized all at once by the effects of persistence of vision of eyes, and are perceivable as three-dimensional images by the action of binocular parallax. However, because light radiated from each of the one-dimensional display devices is radiated as spherical waves, it can be considered that images respectively corresponding to eyes of an observer each enter the mutually-opposite eye as well, and that, in actuality, the binocular parallax is not achieved but rather the images are more likely to be seen double.

On the other hand, Patent Literature 2 discloses a three-dimensional image display device including, between a liquid crystal display element and an observation point, a set of condenser lenses, and a pin hole member sandwiched between the set of condenser lenses. In this three-dimensional image display device, light coming from the liquid crystal display element is converged by one of the condenser lenses to be minimum in diameter at the position of a pin hole of the pin hole member, and the light, which has passed through the pinhole, is made to be collimated light by the other condenser lens (e.g., Fresnel lens). According to such a configuration, images respectively corresponding to left and right eyes of an observer are appropriately allocated so that the binocular parallax is assumed to be achieved.

Moreover, as the one different from the methods described above, there is also a method of generating three-dimensional video using the holographic technology. The holographic technology is the one for artificially reproducing light waves from an object. As to three-dimensional video using the holographic technology, interference fringes generated as a result of light interference are used, and the diffracted wavefronts generated when the interference fringes are illuminated by light are used itself as a medium for video information. This thus provides a physiological reaction of visual perception such as convergence and adjustment similar to when the observer observes the object in the real world, making it possible to provide a picture with a relatively low level of eye strain. Furthermore, a fact that the wavefronts of light waves from the object are being reproduced means that the continuity is ensured in the direction of transmitting the video information. Therefore, as the eyepoint of the observer moves, an appropriate video from various different angles responsive to the movement can be provided continually. That is, the method of generating three-dimensional video using the holographic technology is a technique for video provision with which the motion parallax is continually provided.

Because the method of generating three-dimensional video using the holographic technology as above is a method of recording the diffracted wavefronts themselves from the object and reproducing these, it is considered as being an extremely ideal method of representing the three-dimensional video.

However, with the holographic technology, information about the three-dimensional space is recorded as interference fringes in the two-dimensional space, and the spatial frequency thereof is enormous in amount compared with the case with the two-dimensional space such as a picture of photographing the same object. This may be because, for converting information about the three-dimensional space into that about the two-dimensional space, the information is converted into the density on the two-dimensional space. Accordingly, the spatial resolution expected for a device of displaying the interference fringes by CGH (Computer Generated Hologram) is extremely high, and an enormous amount of information is in need. Thus, realizing three-dimensional video by real-time hologram is technically difficult under the present circumstances. Moreover, light for use during recording has to be with phase alignment such as laser light, and there is also a problem of not being able to perform recording (photographing) with natural light.

Moreover, the three-dimensional image display device in Patent Literature 2 has the configuration as that of a Fourier transform optical system, and the pin hole is of a certain size (diameter). It is thus considered that, at the position of the pin hole, a component high in spatial frequency (that is, a component high in resolution) is being distributed nonuniformly (distributed more in the peripheral edge section) in the plane orthogonal to the optical axis. Accordingly, for realizing collimated light in the strict sense, there needs to extremely reduce the diameter of the pin hole. However, because the reduction and non-uniformity of image brightness are incurred with reducing diameter of the pin hole and the component high in spatial frequency is removed by the pin hole, it is assumed that the resolution thus also degrades.

In consideration thereof, in recent years, the study has been made for a spatial image display device based on the light beam reproduction method (for example, see Non-Patent Literature 1). The light beam reproduction method is with the aim of representing spatial images by a large number of light beams irradiated from a display, and in theory, provides observers with precise information about the motion parallax and information about the focal length even with observation with naked eyes, so that the resulting spatial images are with the relatively low level of eye strain. Also the applicant has already proposed a spatial image display device for realizing spatial image display based on the light beam reproduction method as such (for example, see Patent Literature 3).

### PRIOR ART LITERATURE

### Patent Literature

Patent Literature 1: Japanese Patent No. 3077930
Patent Literature 2: Japanese Unexamined Patent Application Publication No. 2000-201359
Patent Literature 3: Japanese Unexamined Patent Application Publication No. 2007-86145

### Non-Patent Literature

Non-Patent Literature 1: Yasuhiro TAKAGI, “Three-dimensional Images and Flat-panel Type Three-dimensional Display”, Optical Society of Japan, Volume No. 35, Issue No. 8, 2006, p. 400 to 406

### SUMMARY OF THE INVENTION

Incidentally, for displaying a natural spatial image by the light beam reproduction method, during display of a frame of a general two-dimensional image on a general two-dimensional display, there needs to project about several tens to hundreds of various different two-dimensional images or more toward different directions. However, with the spatial image display device described in Patent Literature 3 or others, one deflection element is provided for one pixel. Therefore, a two-dimensional display incorporated to such a spatial image display device is expected to have the capabilities of displaying about tens to hundreds of various different two-dimensional images or more during display of a frame of a general two-dimensional image on a general two-dimensional display. That is, a frame rate is required to be very high about 1000 to 6000 frames or more per second, for example. However, the two-dimensional display with such a high frame rate is expensive, and the configuration thereof tends to be complicated and large in size. As such, a spatial image display device requiring no such high frame rate for a two-dimensional display, and being able to display more natural spatial images even with a more compact configuration, is desired.

The invention is made in consideration of such problems, and an object thereof is to provide a spatial image display device that can form more natural spatial images even with a simple configuration.

A spatial image display device according to an embodiment of the invention includes: two-dimensional image generation means including a plurality of pixels, and generating a two-dimensional display image corresponding to a video signal; and deflection means for deflecting, in a horizontal direction, display image light coming from each of pixel groups in the two-dimensional image generation means, the pixel group including pixels aligned at least along the horizontal direction.

With the spatial image display device according to the embodiment of the invention, among the display image light coming from the two-dimensional image generation means, the display image light corresponding to one group of pixels is collectively deflected by one deflection means corresponding to that one group of pixels. That is, when the group of pixels aligned in the horizontal direction is configured by n pieces of pixels, from one deflection means corresponding thereto, the n pieces of deflected display image light traveling to mutually-different directions are emitted all at once. Thus, compared with a case where one deflection means is provided for one pixel, a larger number of various different two-dimensional images are to be projected toward different directions in a horizontal plane, without increasing a frame display speed (frame rate) per unit time in the two-dimensional image generation means.

According to the spatial image display device of the embodiment of the invention, one deflection means is provided for one group of pixels to collectively deflect the display image light corresponding to the one group of pixels. Thus, even when a frame rate in the two-dimensional image generation means is of about the same level as the previous one, a larger number of two-dimensional images can be emitted in their appropriate directions. Therefore, it is possible to form more natural spatial images even with a simple configuration.

### BRIEF DESCRIPTION OF THE DRAWINGS

FIG. 1 A schematic diagram showing an exemplary configuration of a spatial image display device as an embodiment of the invention.

FIG. 2 A perspective view showing the configuration of a first lens array shown in FIG. 1, and a plan view showing the placement of pixels in a display section.

FIG. 3 A perspective view showing the configuration of a second lens array shown in FIG. 1.

FIG. 4 A perspective view showing the configuration of a liquid optical element in a wavefront transformation deflection section shown in FIG. 1.

FIG. 5 A conceptual diagram for illustrating the operation of the liquid optical element shown in FIG. 4.

FIG. 6 A conceptual diagram for illustrating the operation in the spatial image display device shown in FIG. 1 when observing three-dimensional video.

FIG. 7 Another conceptual diagram for illustrating the operation in the spatial image display device shown in FIG. 1 when observing three-dimensional video.

### MODE FOR CARRYING OUT THE INVENTION

In the below, an embodiment of the invention is described in detail by referring to the accompanying drawings.

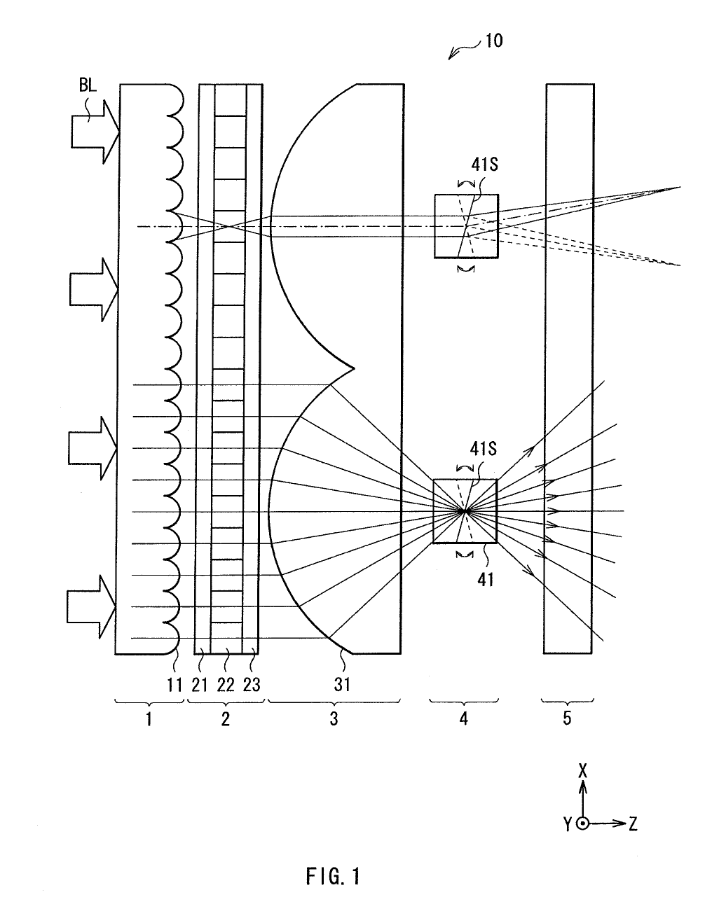

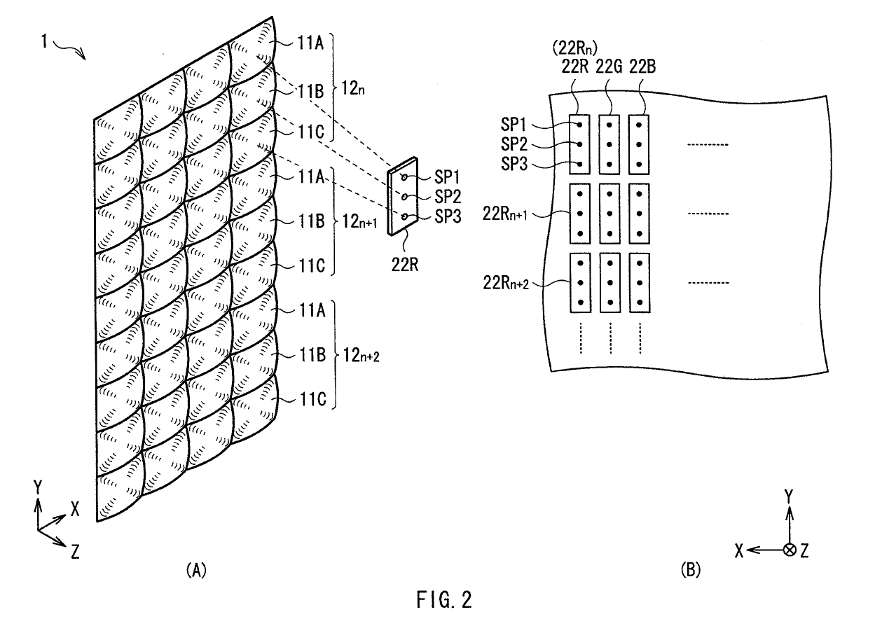

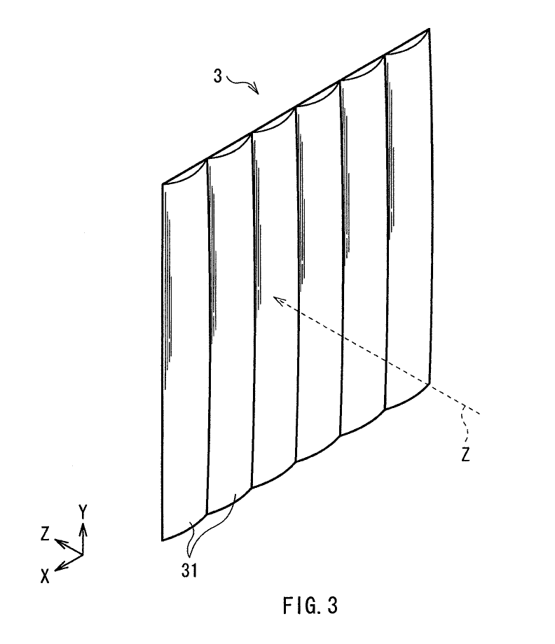

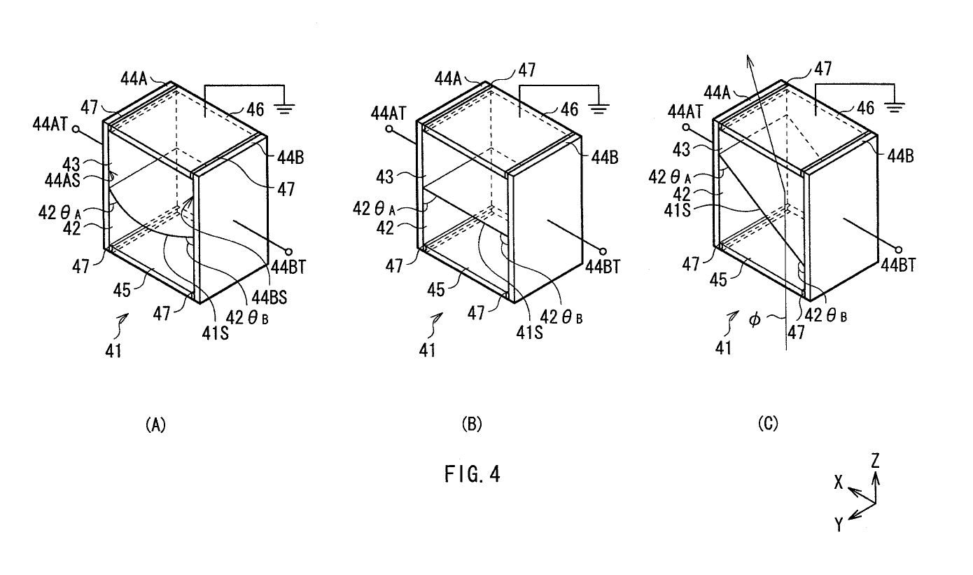

By referring to FIGS. 1 to 4, described is a spatial image display device 10 as the embodiment of the invention. FIG. 1 is a diagram showing an exemplary configuration of the spatial image display device 10 in a horizontal plane. FIG. 2(A) shows the perspective configuration of a first lens array 1 shown in FIG. 1, and FIG. 2(B) shows the placement of pixels 22 (22R, 22G, and 22B) on an XY plane of a display section 2 shown in FIG. 1. FIG. 3 is a diagram showing the perspective configuration of a second lens array 3 shown in FIG. 1. FIG. 4 is a diagram showing the specific configuration of a wavefront transformation deflection section 4 shown in FIG. 1.

### (Configuration of Spatial Image Display Device)

As shown in FIG. 1, the spatial image display device 10 is provided with the first lens array 1, the display section 2 including a plurality of pixels 22 (will be described later), the second lens array 3, the wavefront transformation deflection section 4, and a diffusion plate 5, in order from the side of a light source (not shown).

The first lens array 1 includes a plurality of microlenses 11 (11a, 11b, and 11c), which are arranged in a matrix along the plane (XY plane) orthogonal to the optical axis (Z axis) (FIG. 2(A)). The microlenses 11 are each for converging backlight BL coming from each light source, and for emitting it toward any of the corresponding pixels 22. The microlenses 11 each have the lens surface being spherical, and show the matching between the focal length of light passing through the horizontal plane (XZ plane) including the optical axis with the focal length of light passing through the plane (YZ plane) including the optical axis and being orthogonal to the horizontal plane. The microlenses 11 all preferably have the same focal length f11. For the backlight BL, preferably used is parallel light as a result of collimating light such as fluorescent lamps using a collimator lens, for example.

The display section 2 is for generating a two-dimensional display image corresponding to a video signal, and specifically, is a color liquid crystal device that emits display image light by irradiation of the backlight BL. The display section 2 has a configuration that a glass substrate 21, a plurality of pixels 22 each including a pixel electrode and a liquid crystal layer, and a glass substrate 23 are laminated together, in order from the side of the first lens array 1. The glass substrate 21 and the glass substrate 23 are both transparent, and either of these is provided with a color filter including colored layers of red (R), green (G), and blue (B). As such, the pixels 22 are grouped into the pixels 22R displaying the color of red, the pixels 22G displaying the color of green, and the pixels 22B displaying the color of blue. In such a display section 2, as shown in FIG. 2(B), for example, the pixels 22R, the pixels 22G, and the pixels 22B are repeatedly arranged in order in the X-axis direction, but in the Y-axis direction, the arrangement is so made that the pixels 22 of the same color are aligned. In this specification, for convenience, the pixels 22 aligned in the X-axis direction are referred to as row, and the pixels 22 aligned in the Y-axis direction are referred to as column.

The pixels 22 are each in the rectangular shape extending in the Y-axis direction on the XY plane, and are provided corresponding to microlens groups 12 (FIG. 2(A)), each of which includes a group of microlenses 11a to 11c aligned in the Y-axis direction. That is, the first lens array 1 and the display section 2 have such a positional relationship that light having passed through the microlenses 11a to 11c of the microlens group 12 converges to spots SP1 to SP3 in an effective region of each of the pixels 22 (FIG. 2(A) and FIG. 2(B)). For example, after passing through the microlenses 11A to 11C of the microlens group 12ₙ, the light converges to the spots SP1 to SP3 of the pixel 22Rₙ. Similarly, the light coming from the microlens group 12ₙ₊₁ converges to the pixel 22Rₙ₊₁, and the light coming from the microlens group 12ₙ₊₂ converges to the pixel 22Rₙ₊₂. Note that one pixel 22 may be arranged corresponding to one microlens 11, or one pixel 22 may be arranged corresponding to two or four or more microlenses 11.

The second lens array 3 is for converting the display image light converged by passing through the first lens array 1 and the display section 2 into parallel light in the horizontal plane, and for emitting the same. To be specific, the second lens array 3 is a so-called lenticular lens, and as shown in FIG. 3, for example, has a configuration in which a plurality of cylindrical lenses 31, each having the cylindrical surface surrounding the axis along the Y axis, are aligned along the X-axis direction. Accordingly, the cylindrical lenses 31 provide the refractive power on the horizontal plane including the optical axis (Z axis). In FIG. 1, one cylindrical lens 31 is provided to each of the nine columns of pixels 22 aligned along the X-axis direction, but this number is not limited thereto. Moreover, the cylindrical lenses 31 may each have the cylindrical surface surrounding the axis with a predetermined angle of tilt θ (θ<45°) from the Y axis. The cylindrical lenses 31 all desirably have mutually-equal focal length f31. Furthermore, a distance f13 between the first lens array 1 and the second lens array 3 is equal to the sum of the focal lengths thereof, that is, the sum |f11+f31| of the focal length f11 of the microlenses 11 and the focal length f31 of the cylindrical lenses 31. Therefore, when the backlight BL is parallel light, the light coming from the cylindrical lenses 31 becomes also parallel light in the horizontal plane.

The wavefront transformation deflection section 4 includes one or a plurality of liquid optical elements 41 for one second lens array 3, thereby performing wavefront transformation and deflection with respect to the display image light emitted from the second lens array, 3. To be specific, using the liquid optical element(s) 41, the wavefronts of the display image light emitted from the second lens array 3 are collectively transformed into the wavefronts having a predetermined curvature for each of groups of pixels 22 aligned in both the horizontal direction (X-axis direction) and the vertical direction (Y-axis direction), and also the display image light is collectively deflected in the horizontal plane (in the XZ plane). At this time, the display image light, which has transmitted through the liquid optical element(s) 41, is transformed into a wavefront with an adequate curvature which allows the display image light to converge into a point where, with an arbitrary observation point being a base point, an optical-path length is equal to an optical-path length from this observation point to a virtual object point.

FIGS. 4(A) to 4(C) show the specific perspective configuration of the liquid optical element 41. As shown in FIG. 4(A), the liquid optical element 41 has a configuration in which a non-polarity liquid 42 and a polarity liquid 43, which are transparent and have different refractive indexes and interfacial tensions, are so disposed, on the optical axis (Z axis), as to be sandwiched between a pair of electrodes 44A and 44B made of copper or others. The pair of electrodes 44A and 44B are adhered and fixed to a bottom plate 45 and a top plate 46 via insulation sealing sections 47, respectively. The bottom plate 45 and the top plate 46 are both transparent. The electrodes 44A and 44B are connected to an external power supply (not shown) via terminals 44AT and 44BT connected to the outer surfaces thereof, respectively. The top plate 46 is made of a transparent conductive material such as indium tin oxide (ITO: Indium Tin Oxide) and zinc oxide (ZnO), and functions as a ground electrode. The electrodes 44A and 44B are each connected to a control section (not shown), and each can be set to have a predetermined level of electric potential. Note that the side surfaces (XZ planes) different from the electrodes 44A and 44B are covered by a glass plate or others that is not shown, and the non-polarity liquid 42 and the polarity liquid 43 are in the state of being encapsulated in the space that is completely hermetically sealed. The non-polarity liquid 42 and the polarity liquid 43 are not dissolved and remain isolated from each other in the closed space, and form an interface 41S.

Inner surfaces (opposing surfaces) 44AS and 44BS of the electrodes 44A and 44B are desirably covered by a hydrophobic insulation film. This hydrophobic insulation film is made of a material showing the hydrophobic property (repellency) with respect to the polarity liquid 43 (more strictly, showing the affinity with respect to the non-polarity liquid 42 under an absence of electric field), and having the property excellent in terms of electric insulation. To be specific, exemplified are polyvinylidene fluoride (PVdF) and polytetrafluoroethylene (PTFE) being fluorine high polymer. Note that, for the purpose of improving further the electric insulation between the electrode 44A and the electrode 44B, any other insulation film made of spin-on glass (SOG) or others may be provided between the electrode 44A and the electrode 44B and the hydrophobic insulation film described above.

The non-polarity liquid 42 is a liquid material with almost no polarity and with the electric insulation, and silicone oil or others are suitably used, other than a hydrocarbon material such as decane, dodecane, hexadecane, or undecane. When no voltage is applied between the electrode 44A and the electrode 44B, the non-polarity liquid 42 desirably has the capacity enough to cover entirely the surface of the bottom plate 45. On the other hand, the polarity liquid 43 is a liquid material with the polarity, and an aqueous solution in which an electrolyte such as potassium chloride and sodium chloride is dissolved is suitably used, other than water, for example. When such a polarity liquid 43 is applied with a voltage, the wettability with respect to the inner surfaces 44AS and 44BS (or the hydrophobic insulation film covering thereover) (the contact angle between the polarity liquid 43 and the inner surfaces 44AS and 44BS (or the hydrophobic insulation film covering thereover)) shows a large change compared with the non-polarity liquid 42. The polarity liquid 43 is being in contact with the top plate 46 as a ground electrode.

The non-polarity liquid 42 and the polarity liquid 43 that are so encapsulated as to be enclosed by a pair of electrodes 44A and 44B, the bottom plate 45, and the top plate 46 are isolated from each other with no mixture, and form the interface 41S. Note that the non-polarity liquid 42 and the polarity liquid 43 are so adjusted as to have almost the same level of specific gravity with respect to each other, and the positional relationship between the non-polarity liquid 42 and the polarity liquid 43 is determined by the order of encapsulation. Because the non-polarity liquid 42 and the polarity liquid 43 are transparent, light transmitting through the interface 41S is refracted in accordance with the angle of incidence thereof and the refractive indexes of the non-polarity liquid 42 and the polarity liquid 43. With this liquid optical element 41, in the state with no voltage application between the electrodes 44A and 44B (in the state when the electrodes 44A and 44B both have the electric potential being zero), as shown in FIG. 4(A), the interface 41S is curved convex from the side of the polarity liquid 43 toward the non-polarity liquid 42. A contact angle 42θA of the non-polarity liquid 42 with respect to the inner surface 44AS, and a contact angle 42θB of the non-polarity liquid 42 with respect to the inner surface 44BS can be adjusted by the selection of the type of a material for the hydrophobic insulation film covering the inner surfaces 44AS and 44BS, for example. Herein, when the non-polarity liquid 42 has the refractive index larger than the polarity liquid 43, the liquid optical element 41 provides the negative refractive power. On the contrary, when the non-polarity liquid 42 has the refractive index smaller than the polarity liquid 43, the liquid optical element 41 provides the positive refractive power. For example, when the non-polarity liquid 42 is a hydrocarbon material or silicone oil, and when the polarity liquid 43 is water or an electrolytic aqueous solution, the liquid optical element 41 provides the negative refractive power. The interface 41S has a constant curvature in the Y-axis direction, and this curvature becomes the largest in this state (the state with no voltage application between the electrodes 44A and 44B).

When a voltage is applied between the electrodes 44A and 44B, as shown in FIG. 4(B), for example, the curvature of the interface 41S is reduced, and when a voltage of a predetermined level or higher is applied, the flat surface is derived. That is, the contact angles 42θA and 42θB both become right angles (90°). This phenomenon is assumed as below. That is, by the voltage application, an electric charge is accumulated to the surfaces of the inner surfaces 44AS and 44BS (or the hydrophobic insulation film covering thereover), and by the Coulomb force of the electric charge, the polarity liquid 43 with the polarity is pulled toward the hydrophobic insulation film. Thus, the area of the polarity liquid 43 being in contact with the inner surfaces 44AS and 44BS (or with the hydrophobic insulation film covering thereover) is increased, and on the other hand, the non-polarity liquid 42 is so moved (deformed) by the polarity liquid 43 as to be excluded from the part where it is being in contact with the inner surfaces 44AS and 44BS (or with the hydrophobic insulation film covering thereover). As a result, the interface 41B becomes more like the flat surface. Note that FIG. 4(B) shows a case where the electric potential of the electrode 44A (assumed as Va) and the electric potential of the electrode 44B (assumed as Vb) are equal to each other (Va=Vb). When the electric potential Va and the electric potential Vb are different from each other, as shown in FIG. 4(C), for example, derived is a flat surface tilted with respect to the X axis and the Z axis (with respect to the Y axis, a surface parallel thereto) (42θA≠42θB). Note that FIG. 4(C) shows a case where the electric potential Vb is larger than the electric potential Va (the contact angle 42θB is larger than the contact angle 42θA). In this case, for example, incoming light having entered the liquid optical element 41 after moving parallel to the electrodes 44A and 44B is refracted in the XZ plane in the interface 41S, and then is deflected. As such, by adjusting the magnitudes of the electric potential Va and the electric potential Vb, the incoming light becomes able to be deflected in a predetermined direction in the XZ plane.

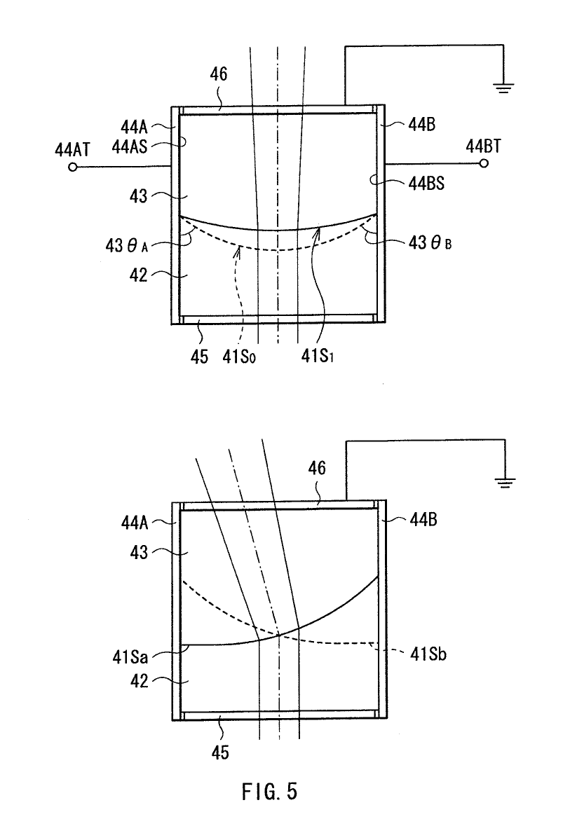

Moreover, the interface 41S is adapted to be changed in curvature through magnitude adjustment of the electric potential Va and the electric potential Vb. For example, when the electric potentials Va and Vb (assumed as Va=Vb) are lower in value than an electric potential Vmax in a case where the interface 41S is a horizontal plane, as shown in FIG. 5(A), for example, derived is an interface 41S₁ (indicated by solid lines) with a curvature smaller than an interface 41S₀ (indicated by broken lines) when the electric potentials V1 and V2 are zero. Therefore, the refractive power exerted on light transmitting through the interface 41S can be adjusted by changing the magnitudes of the electric potential Va and the electric potential Vb. That is, the liquid optical element 41 functions as a variable focus lens. Moreover, in that state, when the electric potential Va and the electric potential Vb become different from each other in magnitude (Va≠Vb), the interface 41S is tilted in state while keeping an appropriate curvature. For example, when the electric potential Va is higher (Va>Vb), formed is an interface 41Sa indicated by solid lines in FIG. 5(B). On the other hand, when the electric potential Vb is higher (Va<Vb), formed is an interface 41Sb indicated by broken lines in FIG. 5(B). Accordingly, by adjusting the magnitudes of the electric potential Va and the electric potential Vb, the liquid optical element 41 becomes able to deflect incoming light in a predetermined direction while exerting an appropriate level of refractive power with respect to the incoming light. Note that, FIGS. 5(A) and 5(B) show, when the non-polarity liquid 42 has the refractive index larger than the polarity liquid 43, and when the liquid optical element 41 exerts the negative refractive power, a change of the incoming light when the interfaces 41S₁ and 41Sa are formed.

The diffusion plate 5 is for diffusing light from the wavefront transformation deflection section 4 only in the vertical direction (Y-axis direction). The light from the wavefront transformation deflection section 4 is adapted not to be diffused in the X-axis direction. As such a diffusion plate 5, a lens diffusion plate (Luminit (USA), LLC; model LSD40×0.2 or others) may be used, for example. Alternatively, like the second lens array 3 shown in FIG. 3, for example, a lenticular lens may be used in which a plurality of cylindrical lenses are arranged. Note that, in this case, the cylindrical lenses each have the cylindrical surface surrounding the axis along the X axis, and are aligned in the Y-axis direction. Moreover, the cylindrical surfaces of the cylindrical lenses may have a curvature as large as possible, and the lenticular lenses may be increased in number per unit length in the Y-axis direction. Note that, herein, the diffusion plate 5 is disposed on the projection side of the second lens array 3, but may be disposed between the first lens array 1 and the second lens array 3.

### (Operation of Spatial Image Display Device)

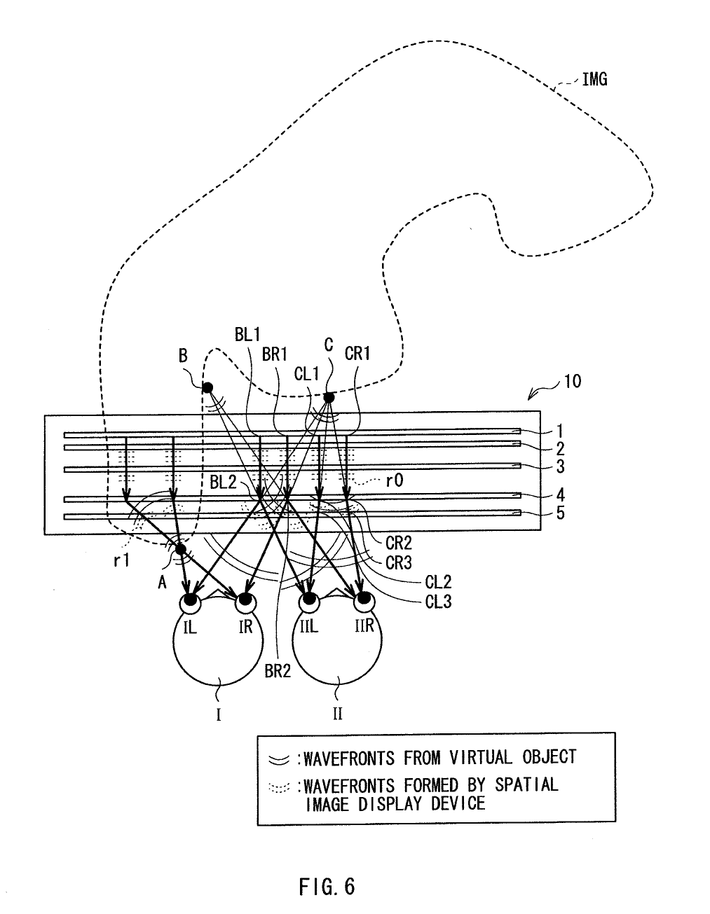

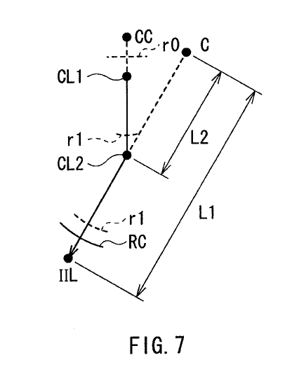

Next, the operation of the spatial image display device 10 is described by referring to FIGS. 6 and 7.

Generally, for observing an object point on a certain object, by observing spherical waves emitted from the object point being as a point source, an observer perceives it as a “point” existing at a unique position in the three-dimensional space. Usually, in the natural world, the wavefronts emitted from an object propagate at the same time, and reach the observer constantly and continuously with a certain wavefront shape. However, other than the holographic technology under the current circumstances, reproducing simultaneously and continuously the wavefronts of light waves at each point in the space is difficult. However, even when there is a certain virtual object and light waves are emitted from each virtual point, and even when the time for each of the light waves to reach the observer is somewhat inaccurate or even when the light waves reach not continuously but as intermittent optical signals, the human eyes can observe the virtual object with no unnatural feeling because of the integral action thereof. With the spatial image display device 10A in this embodiment, by forming the wavefronts at each point in the space in orderly time sequence at a high speed by utilizing the integral action of the human eyes as such, it is possible to form the three-dimensional images that are more natural than before.

With the spatial image display device 10, spatial images can be displayed as below. FIG. 6 is a conceptual view showing the state in which observers I and II observe a virtual object IMG as three-dimensional video using the spatial image display device 10. In the below, the operating principles thereof are described.

As an example, video light waves of an arbitrary virtual object point (e.g., a virtual object point B) on the virtual object IMG are formed as below. First of all, two types of images respectively corresponding to the left and right eyes are displayed on the display section 2. At this time, the backlight BL (not shown herein) is irradiated from a light source to the first lens array 1, and light transmitting through a plurality of microlenses 11 is converged to each corresponding pixel 22. After reaching each of the pixels 22, the light is directed toward the second lens array 3 while diverging as display image light. The display image light from each of the pixels 22 is converted into parallel light in the horizontal plane when passing through the second lens array 3. As a matter of course, because displaying two images at the same time is impossible, these images are displayed one by one, and then are eventually forwarded in succession to the left and right eyes, respectively. For example, an image corresponding to a virtual object point C is displayed both at a point CL1 (for the left eye) and a point CR1 (for the right eye) in the display section 2. At this time, to the pixels 22 at the point CL1 (for the left eye) and at the point CR1 (for the right eye) in the display section 2, converging light is irradiated from their corresponding microlenses 11. The display image light emitted from the display section 2 transmits sequentially through the second lens array 3, the wavefront transformation deflection section 4 in the horizontal direction, and the diffusion plate 5, and then reaches each of a left eye IIL and a right eye IIR of the observer II. Similarly, an image of the virtual object point C for the observer I is displayed both at a point BL1 (for the left eye) and at a point BR1 (for the right eye) in the display section 2, and after transmitting sequentially through the second lens array 3, the wavefront transformation deflection section 4, and the diffusion plate 5, reaches each of a left eye IL and a right eye IR of the observer I. Because this operation is performed at a high speed within a time constant of the integral effects of the human eyes, the observers I and II can perceive the virtual object point C without noticing that the images are being forwarded in succession.

The display image light emitted from the second lens array 3 is directed to the wavefront transformation deflection section 4 as parallel light in the horizontal plane. In the second lens array 3, by the display image light being converted into the parallel light, and by the focal distance being made infinite, information derived from the physiological function of adjusting the focal length of eyes can be deleted once from information about the position of a point from which light waves are irradiated. FIG. 6 shows the wavefronts of light directed from the second lens array 3 to the wavefront transformation deflection section 4 as parallel wavefronts r0 orthogonal to the direction of travel. Thereby, brain confusion resulting from no-matching between information from the binocular parallax/angle of convergence and information from the focal length is eased.

The display image light irradiated from the points CL1 and CR1 of the display section 2 respectively reach the points CL2 and CR2 of the wavefront transformation deflection section 4 after traveling the second lens array 3. The light waves reaching the points CL2 and CR2 of the wavefront transformation deflection section 4 as such are deflected in a predetermined direction in the horizontal plane, and then reach points CL3 and CR3 of the diffusion plate 5 after being provided with appropriate focal length information corresponding to each of the pixels 22. The focal distance information is provided by transforming the flat wavefronts r0 into curved wavefronts r1. This will be described in detail later.

After reaching the diffusion plate 5, the display image light is diffused by the diffusion plate 5 in the vertical plane, and then is irradiated toward each of the left eye IIL and the right eye IIR of the observer II. Herein, for example, in such a manner that the wavefronts of the display image light reach the point CL3 when the deflection angle is directed to the left eye IIL of the observer II, and in such a manner that the wavefronts of the display image light reach the point CR when the deflection angle is directed to the right eye IIR of the observer II, the display section 2 forwards the image light in synchronization with the deflection angle by the wavefront transformation deflection section 4. At the same time, the wavefront transformation deflection section 4 may operate to transform the wavefronts r0 into the wavefronts r1 in synchronization with its own deflection angle. With the wavefronts of the image light irradiated from the diffusion plate 5 reaching the left eye IIL and the right eye IIR of the observer II, the observer II can perceive the virtual object point C on the virtual object IMG as a point in the three-dimensional space. Similarly to the virtual object point B, the image light irradiated from points BL1 and BR1 of the display section 2 respectively reach points BL2 and BR2 in the wavefront transformation deflection section 4 after traveling the second lens array 3. The light waves reaching the points BL2 and BR2 are deflected in a predetermined direction in the horizontal plane, and then are respectively irradiated toward each of the left eye IIL and the right eye IIR of the observer II after being diffused by the diffusion plate 5 in the vertical plane. Note that, FIG. 6 shows the state of, at the points BL1 and BR2 of the display section 2, displaying the image of the virtual object point C for the observer I, and the state of displaying the image of the object point B for the observer II. However, these are not displayed at the same time, but are displayed at different timings.

Herein, by referring to FIG. 7 in addition to FIG. 6, the effects of the wavefront transformation deflection section 4 are described. In the wavefront transformation deflection section 4, the wavefronts r0 of the display image light provided by the display section 2 via the second lens array 3 are transformed into the wavefronts r1 having such a curvature as being in focus at a position where, with an arbitrary observation point being a base point, the optical-path length is equal to the optical-path length from this observation point to a virtual object point. For example, as shown in FIG. 7, when the wavefronts RC of light emitted from the virtual object point C being a light source reach the left eye IIL via an optical-path length L1, the wavefronts are so formed that the wavefronts RC and the wavefronts r1 have the same curvature with respect to each other in the left eye IIL. In this case, on the straight line connecting the point CL2 and the point CL1, a focus point CC corresponding to the wavefronts r1 is assumed as existing at the distance equal to an optical-path length L2 from the point CL2 to the virtual object point C. Thus, assuming that the display image light having the wavefronts r1 is emitted from the focus point CC being as a light source, when the wavefronts r1 of the display image light reach the left eye IIL, they are perceived as if they are the wavefronts RC emitted from the virtual object point C being a light source. Moreover, as shown in FIG. 7, when there is a virtual object point A at the position closer to the observer than the diffusion plate 5, the wavefronts r1 after the transformation in the wavefront transformation deflection section 4 come into focus at the virtual object point A.

Herein, when the liquid optical element 41 provides only the negative refractive power, a lens (positive lens) having the positive refractive power may be additionally provided on the optical axis corresponding to each of the liquid optical elements 41. That is, for making the display image light as converging light, the interface 41S of the liquid optical element 41 may be made closer the flat surface, or the interface 41S may be reduced in curvature to enhance the effects of the positive lens. On the other hand, for making the display image light as divergence light, the interface 41S may be increased in curvature to reduce the effects of the positive lens. On the contrary, when the liquid optical element 41 provides only the positive refractive power, a lens (negative lens) having the negative refractive power may be additionally provided on the optical axis corresponding to each of the liquid optical elements 41.

As a result, the brain confusion resulting from no-matching between information from the binocular parallax/angle of convergence and information from the focal length is completely resolved.

Moreover, by collimating the display image light irradiated from the display section 2 in the horizontal plane in the second lens array 3, the following effects can be achieved. For ensuring the binocular parallax, there needs to forward two types of images respectively corresponding to the left and right eyes. That is, the display image light respectively corresponding to the left and right eyes are not allowed to each enter the mutually-opposite eye. Assuming that if the second lens array 3 is not provided, and if spherical waves are irradiated from the display section 2 being a light source, even if the wavefront transformation deflection section 4 is operated for deflection, unwanted display image light enters also to the other eye on the opposite side. In this case, the binocular parallax is not achieved, and the resulting image is seen double. Thus, as in this embodiment, by converting the display image light from the display section 2 into a parallel luminous flux in the second lens array 3, the display image light does not spread in a fan-like shape, thereby reaching only one target eye without entering the other eye.

As such, with the spatial image display device 10, the display section 2 generates two-dimensional display image light corresponding to a video signal. The liquid optical element(s) 41 of the wavefront transformation deflection section 4 deflect the display image light, and transform the wavefronts r0 of the display image light into the wavefronts r1 having a desired curvature. As a result, the following effects can be achieved. That is, by transforming the wavefronts r0 of the display image light of the display section 2 into the wavefronts r1, the display image light includes not only information about the binocular parallax, the angle of convergence, and the motion parallax but also appropriate focal length information. This thus allows an observer to establish consistency between the information about the binocular parallax, the angle of convergence, and the motion parallax and the appropriate focal length information so that he or she can perceive a desired three-dimensional video without physiologically feeling strangeness. Moreover, in the wavefront transformation deflection section 4, because the deflection operation in the horizontal plane is performed in addition to the wavefront transformation operation described above, a simple and compact configuration is realized.

Furthermore, in the wavefront transformation deflection section 4, display image light corresponding to a group of pixels 22 aligned in both the horizontal direction and the vertical direction is collectively subjected to wavefront transformation and collectively deflected by the one liquid optical element 41 corresponding to that group of pixels 22. Accordingly, compared with a case where one liquid optical element 41 is provided for one pixel 22, a larger number of various different two-dimensional display image light is to be emitted all at once toward various different directions in the horizontal plane, without increasing the frame display speed (frame rate) per unit time in the display section 2. Therefore, more natural spatial images can be formed while maintaining the simple configuration.

Moreover, because the diffusion plate 5 is used to diffuse the display image light in the vertical direction, even when an observer stands at a position somewhat off from the up-and-down direction (vertical direction) of the screen, the observer can view the spatial image.

Note that, in this embodiment, the display image light is deflected in the horizontal direction in the wavefront transformation deflection section 4. In addition thereto, any other deflection means may be provided for deflecting the display image light in the vertical direction. If this is the case, those other deflection means can also perform the deflection operation in the vertical plane, and thus even when the virtual line connecting the eyes of an observer is off the horizontal direction (e.g., when the observer is in the posture of lying down), the three-dimensional viewing is possible since a predetermined image reaches the right and left eyes.

As such, although the invention is described by exemplifying several embodiments, the invention is not limited to the embodiments described above, and various many modification can be devised. In the embodiments described above, for example, described is the case of using a liquid crystal device as a display device, but this is not restrictive. For example, self-emitting elements such as organic EL elements, plasma light-emitting elements, field emission (FED) elements, and light-emitting diodes (LED) may be arranged in an array for application as a display device. When such a self-emitting display device is used, there is no need to separately provide a light source for backlight use, thereby being able to achieve a more simplified configuration. Further, the liquid crystal device described in the embodiments above is the one functioning as a transmission-type light valve, but alternatively, a reflective-type light valve such as GLV (Grating Light Valve) or DMD (Digital Multi Mirror) may be used as a display device.

Still further, in the embodiment described above, the deflection means performs wavefront transformation and deflection on display image light coming from the two-dimensional image generation means for each of pixel groups aligned in both the horizontal direction (X-axis direction) and the vertical direction (Y-axis direction). Alternatively, a group of pixels aligned only in the horizontal direction may be treated as a unit. If this is the case, light beams emitted from the spatial image display device can be more like parallel light, and as a result, a spatial image with less blurring can be displayed.

Still further, in the embodiment described above, the liquid optical element 41 as the deflection means performs the wavefront transformation operation and the deflection operation at the same time with respect to the display image light coming from the two-dimensional image generation means, although only the deflection operation may be performed. Alternatively, instead of the liquid optical element 41, a mechanism in charge of the wavefront transformation operation (wavefront transformation section) and a mechanism in charge of the deflection operation (deflection section) may be separately provided.

1. A spatial image display device, comprising:
two-dimensional image generation means including a plurality of pixels, and generating a two-dimensional display image corresponding to a video signal; and
deflection means for deflecting, in a horizontal direction, display image light coming from each of pixel groups in the two-dimensional image generation means, the pixel group including pixels aligned at least along the horizontal direction.

2. The spatial image display device according to claim 1, wherein the deflection means is a liquid optical element including:
a pair of electrodes; and
polarity liquid and non-polarity liquid,
the polarity liquid and the non-polarity liquid having refractive indexes different from each other and being encapsulated between the pair of electrodes with a state isolated from each other in a direction of an optical axis.

3. The spatial image display device according to claim 1, wherein the deflection means further includes a function of transforming a wavefront of the display image light from the two-dimensional image generation means into a wavefront with an adequate curvature which allows the display image light to converge into a point where, with an arbitrary observation point being a base point, an optical-path length is equal to an optical-path length from this observation point to a virtual object point.

4. The spatial image display device according to claim 1, further comprising a lens array converting the display image light from each of the pixels or each of pixel groups in the two-dimensional image generation means into parallel light, and allowing the converted light to pass therethrough.

5. The spatial image display device according to claim 4, wherein the lens array is configured of a plurality of cylindrical lenses each having a cylindrical surface surrounding an axis along a vertical direction and being arranged side by side in a plane orthogonal to an optical axis.

6. The spatial image display device according to claim 4, further comprising an anisotropic diffusion plate disposed between the two-dimensional image generation means and the lens array, or on a light-projection side of the lens array, the anisotropic diffusion plate allowing incident light to be dispersed in a vertical direction.

7. The spatial image display device according to claim 1, wherein the polarity liquid is in contact with a ground electrode disposed away from the pair of electrodes.

8. The spatial image display device according to claim 1, wherein opposing surfaces of the pair of electrodes are covered with insulation films, the insulation films each having an affinity for the non-polarity liquid under an absence of electric field.

9. The spatial image display device according to claim 2, wherein the polarity liquid is in contact with a ground electrode disposed away from the pair of electrodes.

10. The spatial image display device according to claim 2, wherein opposing surfaces of the pair of electrodes are covered with insulation films, the insulation films each having an affinity for the non-polarity liquid under an absence of electric field.

11. A spatial image display device, comprising:
two-dimensional image generation means including a plurality of pixels, and generating a two-dimensional display image corresponding to a video signal; and
deflection means for deflecting, in a horizontal direction, display image light coming from each of pixel groups in the two-dimensional image generation means, the pixel group including pixels aligned at least along the horizontal direction,
wherein one of the deflection means corresponding to one pixel group allows the display image light from the pixel group to be collectively deflected.

12. The spatial image display device according to claim 2, wherein the deflection means further includes a function of transforming a wavefront of the display image light from the two-dimensional image generation means into a wavefront with an adequate curvature which allows the display image light to converge into a point where, with an arbitrary observation point being a base point, an optical-path length is equal to an optical-path length from this observation point to a virtual object point.
